(19) United States
(12) Patent Application Publication
(10) Pub. No.: US 2022/0084111 A1
(43) Pub. Date: Mar. 17, 2022

(54) SYSTEMS AND METHODS FOR MANAGING RESOURCE ACCOUNTS

(71) Applicant: The Toronto-Dominion Bank, Toronto (CA)

(72) Inventors: Matthew Renold LADZIK, Waterloo (CA); Daniel Scott BROTHERSTON, Kitchener (CA); Harrison Michael James REILLY, Toronto (CA); Kyryll ODOBETSKIY, Waterloo (CA); Estelle CHUNG, Toronto (CA); Tri Nhan NGUYEN, Mississauga (CA); Frank John Eldridge FLITTON, Kitchener (CA)

(73) Assignee: The Toronto-Dominion Bank, Toronto (CA)

(21) Appl. No.: 17/017,756

(22) Filed: Sep. 11, 2020

(51) Int. Cl. G06Q 40/02; G06Q 20/40; G06F 9/50

(52) U.S. Cl. CPC G06Q 40/02; G06F 9/5011; G06Q 20/401

(57) ABSTRACT

A processor-implemented is disclosed. The method includes: receiving, via a client device associated with a first resource account, a user input including selection of a first operation and operation identifiers associated with the first operation; determining a first quantity of resources associated with the first operation; identifying one or more second resource accounts that are associated with the operation identifiers; obtaining transaction events data for the one or more second resource accounts; determining a resource allocation for the first resource account in connection with the first operation based on the first quantity of resources and the transaction events data for the one or more second resource accounts; detecting a transaction event associated with the first resource account; and in response to detecting the transaction event associated with the first resource account: determining that the transaction event results in a change to the resource allocation; and transmitting, to the client device, a signal representing a notification indicating the change to the resource allocation.

### TECHNICAL FIELD

The present disclosure relates to resource management and, in particular, to systems and methods for managing allocation of resources associated with resource accounts in a networked environment.

### BACKGROUND

Computing systems are typically employed to manage resource accounts. A computing system may, for example, control access to a plurality of different resource accounts, detect or perform various account operations in connection with the resource accounts, and allocate resources toward scheduled or requested account operations. Resource accounts may be engaged in a large number of complex account operations. For account management systems, it is important to efficiently and accurately allocate available resources among the account operations associated with the resource accounts. Delayed or inaccurate allocation of resources may result in too many or too few resources being allocated toward a given account operation. Deficiencies in resource allocation may prevent desired performance of account operations and adversely affect overall availability of resources associated with the resource accounts.

### BRIEF DESCRIPTION OF DRAWINGS

Reference will now be made, by way of example, to the accompanying drawings which show example embodiments of the present application and in which:

FIG. 1 is a schematic operation diagram illustrating an operating environment of an example embodiment;

FIG. 2 is a high-level schematic diagram of an example computing device;

FIG. 3 shows a simplified organization of software components stored in memory of the example computing device of FIG. 2;

FIG. 4 shows, in flowchart form, an example method for real-time management of resource accounts;

FIG. 5 shows, in flowchart form, an example method for providing recommendations of resource allocations in connection with a resource account;

FIG. 6 shows, in flowchart form, an example method for determining re-allocations of resources for a resource account responsive to detection of transaction events; and

FIGS. 7A-7C illustrate example display screens of a graphical user interface for a resource allocation application.

Like reference numerals are used in the drawings to denote like elements and features.

### DETAILED DESCRIPTION OF EXAMPLE EMBODIMENTS

In one aspect, the present disclosure describes a computing device. The computing device includes a processor, a communications module coupled to the processor, and a memory coupled to the processor. The memory stores instructions that, when executed, configure the processor to: receive, via a client device associated with a first resource account, a user input including selection of a first operation and operation identifiers associated with the first operation; determine a first quantity of resources associated with the first operation; identify one or more second resource accounts that are associated with the operation identifiers; obtain transaction events data for the one or more second resource accounts; determine a resource allocation for the first resource account in connection with the first operation based on the first quantity of resources and the transaction events data for the one or more second resource accounts; detect a transaction event associated with the first resource account; and in response to detecting the transaction event associated with the first resource account: determine that the transaction event results in a change to the resource allocation; and transmit, to the client device, a signal representing a notification indicating the change to the resource allocation.

In some implementations, determining the first quantity of resources associated with the first operation may include: determining second quantities of resources associated with the first operation for the one or more second resource accounts; and computing at least one average value based on the second quantities of resources.

In some implementations, the instructions, when executed, may further configure the processor to transmit, to the client device, a set of cost recommendations for display on the client device, the cost recommendations being based on the at least one average value.

In some implementations, the operation identifiers associated with the first operation may indicate at least one of: a geographical region, an institution, or a program of study.

In some implementations, the first resource account and the one or more second resource accounts may be managed by the same computing system.

In some implementations, determining a resource allocation for the first resource account in connection with the first operation may include determining a second quantity of the resources of the first resource account that is designated for allocating to the first operation.

In some implementations, determining a resource allocation for the first resource account in connection with the first operation may include: determining at least one contribution in connection with the first operation based on the transaction events data for the one or more second resource accounts; and computing a difference between the first quantity of resources and the at least one contribution in connection with the first operation.

In some implementations, determining the at least one contribution in connection with the first operation may include obtaining scholarship amounts data based on the transaction events data for the one or more second resource accounts.

In some implementations, determining the at least one contribution in connection with the first operation may include obtaining income amounts data based on the transaction events data for the one or more second resource accounts.

In some implementations, detecting a transaction event associated with the first resource account may include detecting at least one of: a cheque deposit transaction, a resource transfer transaction, or a withdrawal transaction.

In another aspect, the present disclosure describes a processor-implemented method. The method includes: receiving, via a client device associated with a first resource account, a user input including selection of a first operation and operation identifiers associated with the first operation; determining a first quantity of resources associated with the first operation; identifying one or more second resource accounts that are associated with the operation identifiers; obtaining transaction events data for the one or more second resource accounts; determining a resource allocation for the first resource account in connection with the first operation based on the first quantity of resources and the transaction events data for the one or more second resource accounts; detecting a transaction event associated with the first resource account; and in response to detecting the transaction event associated with the first resource account: determining that the transaction event results in a change to the resource allocation; and transmitting, to the client device, a signal representing a notification indicating the change to the resource allocation.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “resources” may refer broadly to, among others, computing resources (e.g. memory, processor cycles), stored value (e.g. fiat currency), data (e.g. digital data), and/or properties that are owned by or otherwise associated with specific entities. As used herein, the terms “account”, “user account”, and “resource account” may be used interchangeably to refer to a relationship that a user has with a specific entity. For example, a resource management entity, such as a financial institution, may provide resource accounts to its customers and make the customers' resources available through their respective accounts. Examples of resource accounts include: data accounts, utility accounts, checking accounts, deposit accounts, savings accounts, investment accounts, credit accounts, and loan accounts. Resources can be shared, transferred, loaned, etc. as between two or more resource accounts.

A resource account may be engaged in various account operations or transactions that affect the resource level associated with the account. For example, resource transfer operations, which transfer defined quantities of resources to and from an account, can increase or decrease the overall quantity of available resources for the account. For computing systems that manage resource accounts, it is important for the systems to be able to process account operations in real-time, and to efficiently and accurately allocate resources toward the account operations. Inefficiencies in resource allocation can hinder processing of account operations, and lead to errors in account and resource tracking.

In an embodiment, the present application discloses a resource account management system. The system enables users to monitor account operations and resource levels associated with their resource accounts in real-time. In particular, the system is configured to automatically update allocation of resources associated with a user account based on account operations data for the user account and for related resource accounts that are managed by the system. In accordance with present embodiments, the system receives input of operation data associated with a first account operation. Based on the operation data, the system determines a quantity of resources associated with the first account operation. The system also identifies related resource accounts that are associated with the inputted operation data, and obtains account operations data for the related resource accounts. The account operations data may, for example, include transaction events data for the related resource accounts. The system determines a resource allocation for the user account in connection with the first account operation based on the quantity of resources associated with the account operation and the account operations data for the related resource accounts.

In another embodiment, the present application discloses a system for monitoring account operations associated with one or more resource accounts. Upon determining a resource allocation for a user account in connection with a first account operation, the system monitors account operations, including transaction events, associated with the user account. The system determines whether detected account operations result in a change to the resource allocation for the user account in connection with the first account operation. If there is such change to the resource allocation, or if the system determines that such change is likely, the system may determine a re-allocation of resources for the user account in view of the detected account operations.

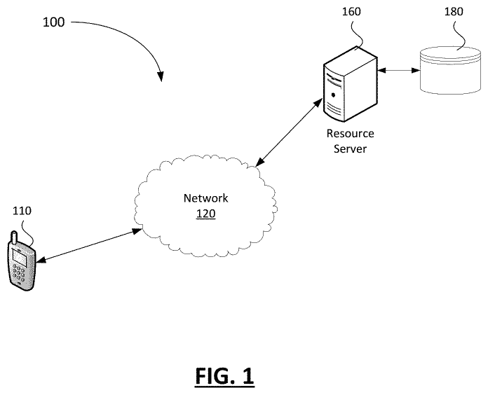

FIG. 1 is a schematic diagram illustrating an operating environment of an example embodiment. In particular, FIG. 1 illustrates exemplary components of a system 100 for allocating resources of a resource account to account operations that are associated with the resource account.

As illustrated, a resource server 160 (which may also be referred to as a server computer system) and client device 110 communicate via the network 120. The client device 110 is a computing device that is associated with an entity, such as a user or client, having resources that are associated with the resource server 160. For example, the resource server 160 may track, manage, maintain, and/or lend resources to the entity. The resource server 160 may be coupled to a database 180, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

The database 180 may include records for a plurality of accounts and at least some of the records may define a quantity of resources associated with an entity. For example, the entity that is associated with the client device 110 may be associated with an account having one or more records in the database. The records may reflect a quantity of stored resources that are associated with the entity. Such resources may include owned resources and, in at least some embodiments, borrowed resources (e.g. resources available on credit). The quantity of resources that are available to or associated with an entity may be reflected by a balance defined in an associated record such as, for example, a bank balance.

The resource server 160 may, for example, be a financial institution server and the entity may be a customer of a financial institution operating the financial institution server.

The client device 110 may be used, for example, to configure a data transfer from an account associated with the client device 110. More particularly, the client device 110 may be used to configure a data transfer from an account associated with an entity operating the client device 110. The data transfer may involve a transfer of data between a record in the database 180 associated with such an account and another record in the database 180 (or in another database such as a database associated with another server (not shown) which may be provided by a different financial institution, for example, and which may be coupled to the resource server 160 via a network). The other record is associated with a data transfer recipient such as, for example, a bill payment recipient. The data involved in the transfer may, for example, be units of value and the records involved in the data transfer may be adjusted in related or corresponding manners. For example, during a data transfer, a record associated with the data transfer recipient may be adjusted to reflect an increase in value due to the transfer, whereas the record associated with the entity initiating the data transfer may be adjusted to reflect a decrease in value which is at least as large as the increase in value applied to the record associated with the data transfer recipient.

The client device 110 is configured to receive input of various information. In particular, a user may input information relating to various operations that are desired to be managed using the client device 110. For example, one or more applications on the client device 110 may allow the user to indicate details about operations associated with the user and quantities of resources allocated to said operations. In some embodiments, the operations may be device operations that are desired to be performed on the client device 110. For example, the user may specify how much computing resources should be allocated to various software applications, and background services that are running on the client device 110. A job scheduler application (or application programming interface, API) may be used for selecting operations, allocating resources to the operations, and automating the operations on the client device 110. Accordingly, the client device 110 may receive input of, among others, job or task identifiers, scheduled time of execution of job, and quantities of computing resources (e.g. network bandwidth, processing power, memory, etc.) allocated to the jobs.

In some embodiments, the operations may be specific tasks or objectives associated with the user. In particular, the client device 110 may be used to manage personal activities and goals of a user (or other entity). For example, a personal financial management (PFM) application may be provided on the client device 110, providing the user with various functionalities relating to financial management. The PFM application may facilitate, for example, creating budgets, tracking personal expenses, cost splitting, scheduling debt payments, automated investments, and creating and monitoring personal budgets. Accordingly, the client device 110 may receive input of, among others, personal finance information, definitions of goals or budgets, and payee information.

The client device 110 and the resource server 160 may be in geographically disparate locations. Put differently, the client device 110 may be remote from the resource server 160. Both the client device 110 and the resource server 160 are computer systems. The client device 110 may take a variety of forms including, for example, a mobile communication device such as a smartphone, a tablet computer, a wearable computer such as a head-mounted display or smartwatch, a laptop or desktop computer, or a computing device of another type.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

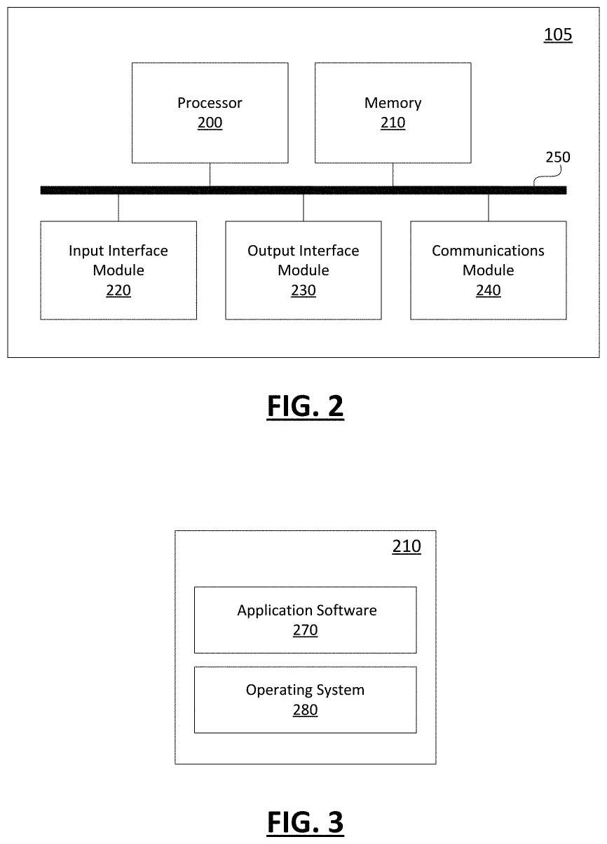

FIG. 2 is a high-level operation diagram of an example computing device 105. In some embodiments, the example computing device 105 may be exemplary of the client device 110 and/or the resource server 160. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball, or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example, allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. The output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communication signals. Communication signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. The communications module 240 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Alternatively, instructions may be executed by the processor 200 directly from read-only memory of memory 210.

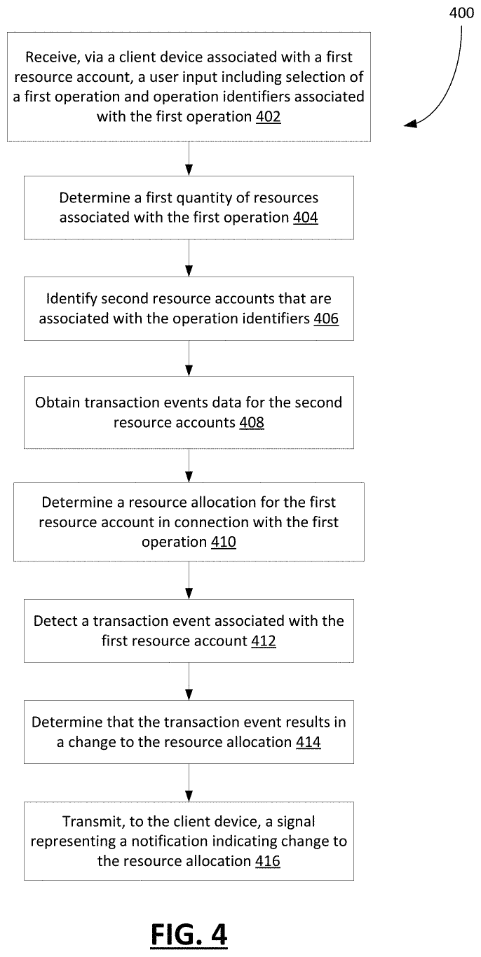

FIG. 3 depicts a simplified organization of software components stored in memory 210 of the example computing device 105. As illustrated, these software components include an operating system 280 and application software 270.

The operating system 280 is software. The operating system 280 allows the application software 270 to access the processor 200, the memory 210, the input interface module 220, the output interface module 230 and the communications module 240. The operating system 280 may be, for example, Apple iOS™, Google Android™, Linux™, Microsoft Windows™, or the like.

The application software 270 adapts the example computing device 105, in combination with the operating system 280, to operate as a device performing a particular function. The application software 270 may, for example, comprise a resource allocation application. A resource allocation application may be used to define operations, tasks, or objectives associated with the client device 110 or a user of the client device 110, and to allocate various quantities of resources to the defined operations/tasks/objectives. The resource allocation application may, for example, be a job scheduler application for managing device operations, such as tasks and background services, and allocating quantities of computing resources to the device operations. A job scheduler may be used to control which tasks (e.g. applications) and background services are actively running on the client device 110, and to manage, in real-time, the allocation of computing resources to those tasks and services. For example, the job scheduler may allow users to define parameters for controlling the quantities of computing resources that can be consumed by individual tasks and services.

As another example, the resource allocation application may be a personal finance management (PFM) application. A PFM application may allow users to track expenses, balances, and savings, and may facilitate personal budgeting. In particular, a PFM application may be used to define various savings goals and set aside (or allocate) resources toward those goals. A savings goal may, for example, specify an activity (or event, purpose, etc.) and a savings value associated with the goal. More generally, a PFM application may allow a user to define one or more account operations, such as transfers from a user-selected account, and quantities of resources associated with the account operations. An account operation is an action that can be taken in connection with a resource account. An account operation is associated with a specific resource account and a resource quantity that is defined by a user. For example, a resource transfer operation from a user's resource account may be associated with a value representing a quantity of resources that is required for completing the operation. Such value may, in at least some embodiments, be defined by a user (e.g. owner of the resource account).

A PFM application may maintain a list of savings goals defined by a user. The savings goals may be tied to a specific banking account. The PFM application may allocate resources of a selected banking account to the user-defined savings goals. For example, the savings balance and future deposits in a selected savings account may be allocated to the user's savings goals based on one or more allocation rules (e.g. percentages, ratios, etc.) defined by the user. The PFM may ensure that savings balance/deposits of the selected account are allocated according to the user-defined percentages. A PFM application may also allow users to define threshold quantities of resources associated with the selected savings goals. A threshold quantity may, for example, be a minimum quantity of resources that is required to complete a particular savings goal. By way of example, if a savings goal is associated with a specific activity (e.g. payment of school tuition, rent, etc.), the threshold quantity specified by the user may be an expected minimum cost of performing the activity.

The resource allocation application may be a stand-alone application, such as a mobile app, or integrated into another application or software module resident on the example computing device 105 as a sub-function or feature. In some embodiments, features of the resource allocation application may be integrated into a personal banking application. For example, the resource allocation application may be a component of software for managing personal accounts on servers of a bank institution.

The resource allocation application is associated with a backend application server. In at least some embodiments, a resource server (such as resource server 160 of FIG. 1) may also serve as the backend application server for the resource allocation application. In particular, various functions of the resource allocation application may be provided, at least in part, by a resource server. For example, a server associated with a financial institution may perform backend services of the resource allocation application. Thus, the resource server may be configured to access personal finance information for a client, receive financial goals and/or budget data from the client, determine initial allocation of resources to one or more financial goals, and configure re-allocations of resources for one or more accounts associated with the client.

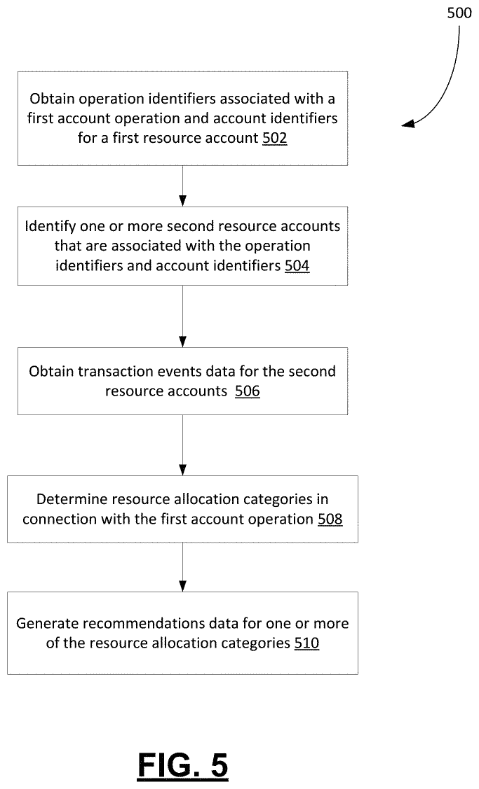

Reference is made to FIG. 4, which shows, in flowchart form, an example method 400 for real-time management of resource accounts. Specifically, the method 400 allows for allocating resources associated with an entity to one or more operations selected by the entity. Operations 402 and onward are performed by one or more processors of computing devices such as, for example, the processor 200 (FIG. 2) of one or more suitably configured instances of the example computing device 105 (FIG. 2).

In at least some embodiments, the method 400 may be performed by a server, such as the resource server 160 of FIG. 1, that is communicably connected to a client device. The server may be a resource server configured for allocating resources to various operations. For example, the server may determine allocations of computing resources to various device operations of the client device. The server may provide computing resources to the client device in quantities as determined by the resource allocations. As another example, the server may be a resource management server which manages one or more resource accounts of the entity associated with the client device. For example, the server may have access to one or more database records corresponding to the entity's resource accounts. The server may allocate resources from the entity's resource accounts to operations or objectives that are selected by the entity using the client device.

In operation 402, the server receives, via a client device associated with a first resource account, a user input including selection of a first operation and operation identifiers associated with the first operation. In at least some embodiments, the first operation is an account operation associated with the first resource account. For example, the first operation may be an outward resource transfer operation representing a transfer of resources that are associated with the first resource account. The operation identifiers associated with the first operation may be defined by a user of the client device. In the case of a resource transfer operation, the operation identifiers may represent user-defined parameters associated with the resource transfer. In particular, the operation identifiers may indicate details of an actual or intended transfer of resources in connection with the first resource account.

As an example, the first operation may be a transfer of computing resources to one or more tasks or processes. The transfer may, for example, be associated with a temporary sharing (e.g. loan) or a permanent re-allocation of computing resources. The operation identifiers may indicate the type and quantity of resource (e.g. processing power, memory, etc.) to be transferred (or shared), the identities of the recipient tasks or processes, time(s) of the transfers, and duration of sharing the resources, among others.

As another example, the first operation may be a transfer of resources from the first resource account to a second resource account (e.g. payee account). For example, the second resource account may be associated with an educational institution, such as a university, and the resource transfer operation may represent a transfer of funds for paying a tuition to the educational institution. In this regard, the operation identifiers of the first operation may indicate at least one of: a geographical region, an institution, or a program of study. The first operation may be selected from a list of one or more predefined operations, or it may be defined in free-form format by a user of the client device. The operation identifiers associated with the first operation may be similarly inputted via the client device.

In operation 404, the server determines a first quantity of resources associated with the first operation. In some embodiments, the first quantity of resources may be inputted as an operation identifier for the first operation. That is, the user of the client device may expressly input a quantity of resources in connection with the first operation. Additionally, or alternatively, the first quantity of resources may be obtained by the server from a different source. For example, the server may retrieve, from a database containing operation data for one or more operations, a quantity corresponding to the first operation. In at least some embodiments, the first quantity may represent a quantity of resources that is required for carrying out the first operation. The server may query a database storing values corresponding to one or more operations to obtain the first quantity of resources. For example, the server may query a costs database to retrieve an operation cost, expressed in terms of quantity of resources, associated with the first operation.

In operation 406, the server identifies one or more second resource accounts that are associated with the operation identifiers. More particularly, the server identifies resource accounts, different from the first resource account, that are associated with the operation identifiers. The second resource accounts thus identified are determined to be related to the first resource account. In at least some embodiments, the second resource accounts may be identified based on matching account data of resource accounts that are managed by the server with the operation identifiers. Account data may indicate, for example, account owner information (such as identifying information), account type, account access settings, any limits associated with the account, and activity history. The server may compare account data of a plurality of resource accounts with the operation identifiers associated with the first operation in identifying the second resource accounts. In particular, a textual comparison of the account data with the operation identifiers may be performed by the server.

As described above, the first resource account and the one or more second resource accounts may be managed by the same computing system. In particular, the server may identify the second resource accounts from among only those resource accounts that are managed by the server.

Once the second resource accounts have been identified, the server obtains transaction events data for the second resource accounts, in operation 408. The transaction events data may indicate, at least, history of activities relating to account operations associated with the second resource accounts. For example, the transaction events data may include historical data identifying various account operations that have occurred in connection with the second resource accounts. The server may maintain, in secure storage, the transaction events data for the resource accounts that the server manages. In particular, the server may store account activity/operations data associated with resource accounts for a certain length of time. The server can retrieve, from the secure storage, transaction events data corresponding to the second resource accounts for selected time periods.

In at least some embodiments, the server may selectively retrieve transaction events data for the one or more second resource accounts. That is, rather than obtaining transaction events data indiscriminately, the server may retrieve only a subset of all account activity/operations data. For example, the server may retrieve only the data for those account operations that satisfy predefined criteria. An account operation may have an associated operation descriptor that indicates, for example, a type and/or description of the account operation. In some embodiments, the server may obtain data for only those account operations whose operation descriptors satisfy predefined criteria. The server may, for example, perform textual comparison of operation descriptors with predefined names/labels and identify, based on the comparisons, those account operations whose operation descriptors yield matches with the names/labels.

In operation 410, the server determines a resource allocation for the first resource account in connection with the first operation. The resource allocation is determined based on the first quantity of resources and the transaction events data for the one or more second resource accounts. The resource allocation represents an allocation of resources associated with the first resource account. In particular, the resource allocation may be an actual or proposed distribution of the resources associated with the first resource account. In at least some embodiments, the resource allocation may take into account the resources currently associated with the first resource account as well as prospective resources that may be obtained for the first resource account. That is, the server may determine allocations of the resources that are currently associated (e.g. contained) in the first resource account and the resources that may or are expected to be obtained in connection with the first resource account.

The quantity of prospective resources for the first resource account may be determined, in some embodiments, based on the transaction events data for the one or more second resource accounts. More specifically, the server may obtain transaction events data for the one or more second resource accounts, which are related to the first operation by the operation identifiers, and determine quantities of resources that may, or are expected to, be obtained for the first resource account based on the transaction events data. For example, the server may determine quantities of resources associated with one or more account operations (e.g. outward resource transfers) that are associated with a second resource account. Since the second resource account and the first resource account are related, the account operations data for at least one of the operations of the second resource account can serve as a basis for determining expected values for operations data associated with the first resource account. In particular, the quantity of prospective resources associated with certain operations for the first resource account may be determined on the basis of corresponding quantities (i.e. quantities for same or similar operations) for the second resource account. Where multiple second resource accounts are identified by the server, the quantity of prospective resources associated with account operations may be determined on the basis of corresponding quantities for multiple ones of the second resource accounts.

In general, the first quantity of resources may represent a cost associated with performance of the first operation, and the resource allocation for the first resource account may represent a distribution of resources associated with the first resource account. For example, in some embodiments, the first quantity of resources may represent a resource cost associated with an outward resource transfer operation, and the resource allocation may be an expected allocation of resources associated with the first resource account to offset the resource cost of the transfer operation. In particular, as part of the resource allocation, the server may determine a second quantity of the resources of the first resource account that is designated for allocating toward the first operation.

In this regard, determining the resource allocation for the first resource account in connection with the first operation may include determining at least one contribution in connection with the first operation based on the transaction events data for the one or more second resource accounts. A contribution, in this sense, represents a defined allocation of resources toward offsetting the resource cost associated with the first operation. The at least one contribution may be categorized. That is, the resource allocation for the first resource account may comprise an allocation of resources into multiple categories of contributions. The categories of contributions may, in some embodiments, be defined by a user, such as the owner of the first resource account. Additionally, or alternatively, one or more predefined categories may be suggested for a resource allocation.

The identification of suitable second resource accounts facilitates the determination of resource cost associated with the first operation. In at least some embodiments, determining the first quantity of resources associated with the first operation may include determining second quantities of resources associated with the first operation for the selected one or more second resource accounts. The server may compute at least one average value based on the second quantities of resources, and the computed value may be taken as being representative of the first quantity of resources. The server may, in some embodiments, transmit, to the client device, a set of cost recommendations that is based on the at least one computed average value for display on the client device.

The server may compute a difference between the first quantity of resources associated with the first operation and the at least one contribution in connection with the first operation. By way of example, in the context of the example of tuition payment, the second resource accounts may be accounts that are owned by students attending an educational institution and program as indicated by the operation identifiers associated with the first operation (i.e. tuition payment transfer operation). In determining the at least one contribution, the server may obtain scholarship amounts data based on the transaction events data for one or more second resource accounts. As another example, the server may obtain income amounts data based on the transaction events data (e.g. cheque deposit transaction, etc.) for the one or more second resource accounts.

In operation 412, the server detects a transaction event associated with the first resource account. More particularly, a transaction event may be detected when a quantity of resources associated with the first resource account is changed (i.e. increased or decreased). The server may be configured to monitor, in real-time, transaction activity for the first resource account. Examples of transaction events that may be detected include, but are not limited to, cheque deposit transactions, outward or inflow resource transfer transactions, and withdrawal transactions.

In response to detecting the transaction event associated with the first resource account, the server determines that the transaction event results in, or can lead to, a change to the resource allocation, in operation 414. In at least some embodiments, the change to the resource allocation may represent an increase or decrease in quantity of resources associated with one or more of the contributions categories. For example, if an outflow resource transfer transaction is detected, the server may determine that the quantity of resources allocated to at least one of the contributions categories has decreased as a result of the transaction. As another example, if an inflow resource transfer transaction (e.g. cheque deposit transaction) is detected, the server may determine that there is an increase in the total quantity of resources associated with the first resource account and that the quantity of resources assigned to at least one of the contributions categories may be increased.

The server then transmits, to the client device, a signal representing a notification indicating the change (or potential change) to the resource allocation, in operation 416. The notification may indicate, at least, the transaction event that triggered the change to the resource allocation, one or more of the contributions categories affected by the change, and the type of change (i.e. increase or decrease). In some embodiments, the server may provide, via the notification, recommendations for changes to the resource allocation. For example, the server may identify one or more of the contributions categories that may undergo change in assigned quantity of resources as a result of the detected transaction event. If, for example, an inflow resource transfer transaction is detected, the server may select at least one of the contributions categories and recommend an increase in the quantity of resources assigned to the selected category. The selection of contributions category by the server may proceed based on, for example, a priority order reflecting the relative importance of the categories.

While the above description of method 400 focuses on the case of a single operation (the “first operation”), it will be understood that the method 400 can be generalized to the case of multiple operations that are associated with the first resource account. That is, the method 400 is extensible to cover the cases of allocating resources of the first resource account in connection with a plurality of operations associated with the first resource account.

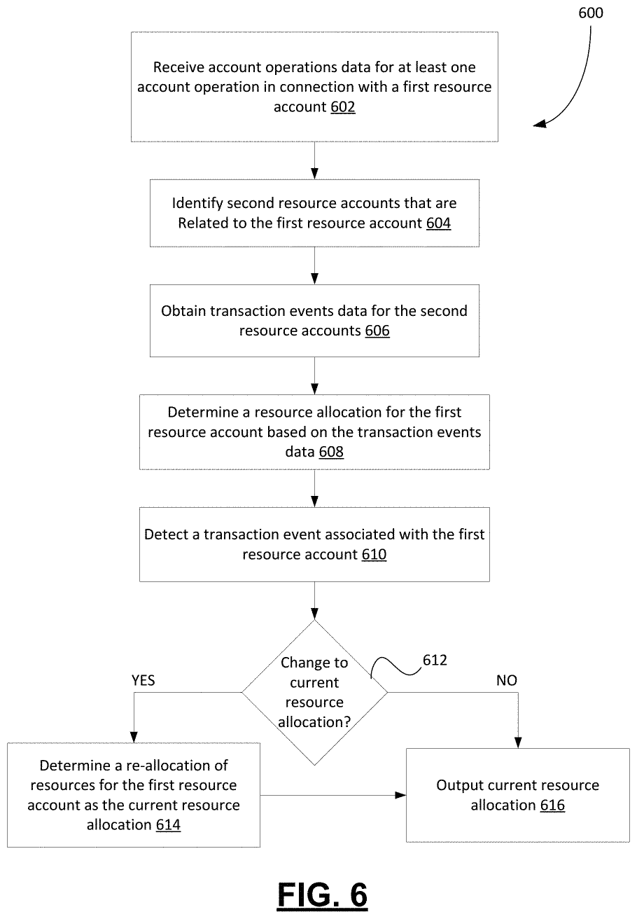

FIG. 5 shows, in flowchart form, an example method 500 for providing recommendations of resource allocations in connection with a resource account. Operations 502 and onward are performed by one or more processors of computing devices such as, for example, the processor 200 (FIG. 2) of one or more suitably configured instances of the example computing device 105 (FIG. 2). As with method 400, the method 500 may be implemented by a server, such as resource server 160 of FIG. 1, that is communicably connected to a client device. The server may be a resource server configured for allocating resources to various operations. It will be understood that the operations of method 500 may be performed in addition to, or as alternatives of, one or more of the operations of method 400 of FIG. 4.

In operation 502, the server obtains operation identifiers associated with a first account operation and account identifiers for a first resource account. For example, the server may receive, via a client device, identifying information for a resource account associated with a client and an indication of an account operation, such as an outflow or inflow resource transfer, in connection with the resource account. The account identifiers may, in some embodiments, include properties/settings/preferences that are associated with the resource account. The server then identifies one or more second resource accounts that are associated with the operation identifiers and account identifiers, in operation 504. The second resource accounts are different from, but are related to, the first resource account. More particularly, the server may perform a search of the resource accounts that are managed by the server to identify those resource accounts with identical or similar account properties as the first resource account, as indicated by the account identifiers. Operations 502 and 504 correspond to, and may be performed in similar manners, as operations 402 and 404 of method 400.

In operation 506, the server obtains transaction events data for the second resource accounts. The transaction activity may be monitored in real-time by the server, or the server may periodically retrieve historical transaction activity data for the second resource account from a secure storage that is accessible by the server.

The server determines resource allocation categories in connection with the first account operation, in operation 508. As detailed above, the resource allocation categories may, in some embodiments, represent categories of contributions towards offsetting the resource cost associated with the first account operation. The resource allocation categories may be determined based on the transaction events data for the second resource accounts. That is, the server may identify one or more relevant contributions categories based on the transaction activity associated with the second resource accounts, and at least a subset of the identified categories may be set as the resource allocation categories for the first resource account. Additionally, or alternatively, the resource allocation categories may be based on one or more predefined categories that are specific to the first resource account. For example, the resource allocation categories may be selected from among a set of predefined categories that are relevant for the particular owner of the first resource account.

In operation 510, the server generates recommendations data for one or more of the resource allocation categories. In particular, the server may generate specific values, representing quantities of resources, for each of one or more of the resource allocation categories. The recommendations data may be transmitted to the client device for display thereon.

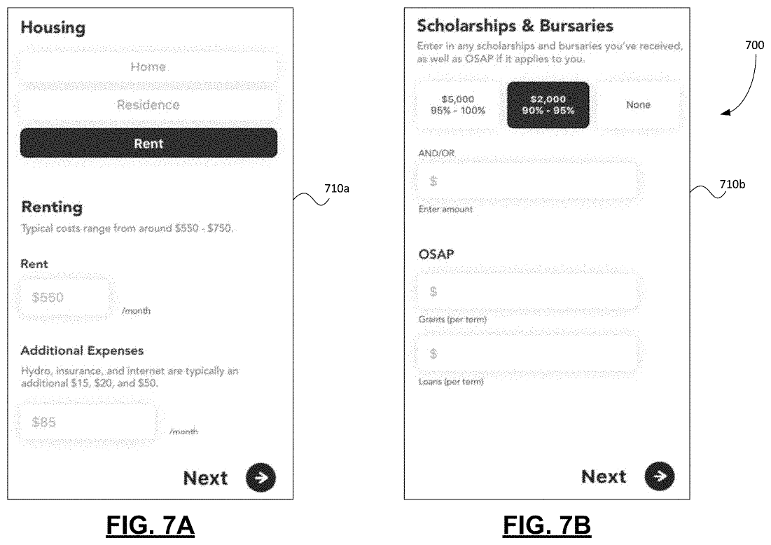

FIG. 6 shows, in flowchart form, an example method 600 for determining re-allocations of resources for a resource account. More particularly, the method 600 may be implemented when re-allocating resources for a resource account responsive to detection of one or more transaction events. Operations 602 and onward are performed by one or more processors of computing devices such as, for example, the processor 200 (FIG. 2) of one or more suitably configured instances of the example computing device 105 (FIG. 2). As with methods 400 and 500, the method 600 may be implemented by a server, such as resource server 160 of FIG. 1, that is communicably connected to a client device. The server may be a resource server configured for allocating resources to various operations. It will be understood that the operations of method 600 may be performed in addition to, or as alternatives of, one or more of the operations of method 400 of FIG. 4 and method 500 of FIG. 5.

In operation 602, the server receives account operations data for at least one account operation in connection with a first resource account. In at least some embodiments, the first resource account may be a banking account, such as a personal checking or savings accounts. The account operations data may identify one or more account operations. The account operations may, for example, be user-defined transaction activities, such as one or more outflow resource transfers, associated with the first resource account. In some embodiments, the account operations data may be retrieved from one or more databases storing data identifying a plurality of different transaction types and predetermined quantities of resources corresponding to the transaction types. For example, the account operations may include different types of outflow resource transfers (e.g. bill payments, expenses, etc.), and the server may query suitable database storing information indicating average values of resource quantities associated with said resource transfers.

In operation 604, the server identifies second resource accounts that are related to the first resource account. The server may first determine account properties associated with the first resource account, such as owner identifying information (e.g. demographic, location, occupation, etc.), account type, and any limits on account operations. The second resource accounts may be identified based on determining matches with the account properties of the first resource account. In particular, the server may identify those resource accounts, managed by the server, that are associated with the same or related account properties as the first resource account. For example, the second resource accounts may be those resource accounts that are owned by clients that have the same occupation or belong to the same demographic group as the owner of the first resource account.

In operation 606, the server obtains transaction events data for the second resource accounts. The server may monitor, in real-time, transaction events data for a plurality of resource accounts, including the identified second resource accounts. The transaction events data may include, at least, historical transaction activity data that identifies transaction activities in connection with the second resource accounts and corresponding quantities of resources associated with the transaction activities. In at least some embodiments, the server may retrieve a subset of all transaction events data for the second resource accounts. For example, only the historical transaction activity data for a predefined set of transaction activities (or transaction types) may be retrieved by the server.

In operation 608, the server determines a resource allocation for the first resource account based on the transaction events data. The resource allocation may be an allocation of resources that are currently associated with the first resource account and that may, or are expected to, be obtained for the first resource account. In at least some embodiments, the transaction events data for the second resource accounts provides indications of those resources that may be acquired for the first resource account. For example, the server may identify one or more transaction types based on the transaction activities for the second resource accounts and determine quantities of resources corresponding to those transaction types based on the transaction events data. The transaction types may include, for example, cheque deposits (e.g. income) and inflow resource transfers (e.g. loans, grants, or scholarship funds). The quantities of resources for the respective transaction types may be determined by, for example, computing averages of the corresponding quantities that are associated with the second resource accounts.

In operation 610, the server detects a transaction event associated with the first resource account. The transaction event may, for example, be a cheque deposit, an inflow or outflow resource transfer transaction, or a withdrawal transaction. In operation 612, the server determines whether there is a change to the current resource allocation. A current resource allocation represents an allocation of resources (including those resources currently associated with the first resource account as well as the resources that may be obtained for the first resource account) into one or more contributions categories. The current resource allocation may indicate actual or expected quantities of resources for each of the one or more contributions categories. The current resource allocation may be dynamically updated based on, for example, transaction events in connection with the first resource account. More specifically, the quantities of resources associated with one or more of the contributions categories may be updated as a result of detected transaction events.

In some embodiments, a resource allocation may indicate a fixed quantity of resources for one or more of the contributions categories that may not be changed. That is, the first resource account may be configured such that account operations that affect the quantities of resources allocated to certain ones of the contribution categories may not be permitted or require specific permissions (e.g. from an owner of the account). In this way, a resource allocation may be a way to set off certain quantities of resources associated with the first resource account that cannot be transferred from the first resource account without additional permissions or discretion of the client.

If the server determines that there is a change to the resource allocation as a result of the detected transaction event, the server determines a re-allocation of resources for the first resource account, in operation 614. This re-allocation is then set as the current resource allocation for the first resource account. A re-allocation of resources is different in at least one contributions category from a previous allocation. That is, a re-allocation represents a difference in the quantity of resources for at least one of the contributions categories. The server may determine a re-allocation based on predetermined settings or rules that govern the allocation of resources associated with the first resource account. For example, the server may determine a re-allocation based on a priority order that is specified in a policy defined for the first resource account.

If, on the other hand, the server determines that there is no change to the current resource allocation, the method 600 proceeds to output the current resource allocation, in operation 616. The current resource allocation may, in some embodiments, be provided to the client device for display thereon. For example, the current resource allocation may be displayed in conjunction with the operations data for the one or more account operations in connection with the first resource account. The display of the current resource allocation may graphically indicate the different categories of contributions to which the resources of the first resource account are allocated.

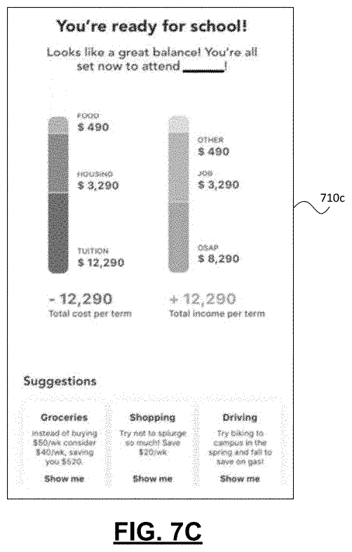

The present disclosure provides various methods that may be implemented by a resource allocation application. Reference is made to FIGS. 7A-7C, which show display screens 710a, 710b, and 710c, respectively, of a graphical user interface for an example resource allocation application 700. In at least some embodiments, the resource allocation application 700 may be used to configure account operations in connection with one or more resource accounts. The resource accounts are associated with resources that are owned by the account holders. For example, the resource accounts may be accounts storing value (e.g. checking account, deposit account, savings account, etc.) belonging to customers of a financial institution, such as a bank. The resource allocation application 700 may provide users with a broad range of account-related functionalities. In particular, the resource allocation application 700 may be used to configure account operations, such as inward and outward resource transfer operations, for user-selected resource accounts. For example, users may define parameters of resource transfer operations using the resource allocation application 700.

Additionally, or alternatively, the resource allocation application 700 may also provide users with the ability to input, modify, and update transfer values in connection with one or more prospective (e.g. scheduled, proposed, etc.) transfer operations associated with the users' resource accounts. For example, as illustrated in FIGS. 7A and 7B, the graphical user interface of the resource allocation application 700 may include user interface elements, such as text input fields, which may be populated with transfer value data. The display screen 710a shows input fields that are associated with example outward resource transfer operations, while the display screen 710b shows input fields that are associated with example inward resource transfer operations. In the examples shown in FIGS. 7A and 7B, the outward resource transfer operations relate to predefined categories of expenses (e.g. rent), and the inward resource transfer operations relate to predefined categories of income (e.g. scholarships, bursaries, loans, etc.). The resource transfer operations represent credits and debits associated with one or more user-selected resource accounts. The graphical user interface of the resource allocation application 700 may allow users to, for example, define actual or prospective account operations, manually input resource transfer values, and manage the inputted transfer values.

The resource allocation application 700 may provide various data which may be useful for resource account holders. For example, the resource allocation application 700 may provide recommendations data identifying recommended resource transfer values in connection with one or more defined account operations (e.g. inward or outward resource transfers). In some embodiments, the recommendations data may be based on resource accounts data in connection with one or more related resource accounts. Specifically, the resource accounts data may include, for example, transaction events data for related resource accounts. The recommendations data may be presented as selectable options or as text output via the graphical user interface.

In some embodiments, the graphical user interface of the resource application 700 may provide a graphical representation of resource transfer values that are associated with prospective account operations (e.g. inward or outward resource transfers). For example, FIG. 7C shows an example display screen 710c that includes a graphical comparison of resource transfer values associated with inward and outward resource transfer operations that relate to a specific activity (e.g. matriculation at an educational institution). The resource transfer operations may be associated with a single or multiple resource accounts. The resource transfer values may be updated manually or automatically, in accordance with the embodiments described in the present disclosure. As an example, the resource transfer values may increase or decrease depending on other account operations associated with the resource account(s). The resource allocation application 700 may enable users to allocate resources (or funds) toward certain prospective account operations based on the comparison data provided by the resource allocation application 700. More particularly, various quantities of resources associated with the resource account(s) may be allocated, or set off, toward certain defined account operations (e.g. resource transfer operations). The resource allocation application 700 may be used to manage and track the various allocations. For example, the resource allocation application 700 may be configured to automatically update the allocated quantities based on other account activities/operations in connection with the resource account(s).

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing device, comprising:
a processor;
a communications module coupled to the processor; and
a memory coupled to the processor, the memory storing instructions that, when executed, configure the processor to:
receive, via a client device associated with a first resource account, a user input including selection of a first resource transfer operation and operation identifiers associated with the first resource transfer operation;
determine a first quantity of resources associated with the first resource transfer operation;
identify one or more second resource accounts related to the first resource account based on matching account data of a plurality of resource accounts with the operation identifiers associated with the first resource transfer operation;
obtain historical account operations data for the one or more second resource accounts;
determine a resource allocation for the first resource account in connection with the first resource transfer operation based on the first quantity of resources and the historical account operations data for the one or more second resource accounts;
detect a second resource transfer operation associated with the first resource account; and
in response to detecting the second resource transfer operation associated with the first resource account:
determine that the second resource transfer operation results in a change to the resource allocation for the first resource account; and
transmit, to the client device, a signal representing a notification indicating the change to the resource allocation.

2. The computing device of claim 1, wherein determining the first quantity of resources associated with the first resource transfer operation comprises:
determining second quantities of resources associated with the first resource transfer operation for the one or more second resource accounts; and
computing at least one average value based on the second quantities of resources.

3. The computing device of claim 2, wherein the instructions, when executed, further configure the processor to transmit, to the client device, a set of cost recommendations for display on the client device, the cost recommendations being based on the at least one average value.

4. The computing device of claim 1, wherein the operation identifiers associated with the first resource transfer operation indicate at least one of: a geographical region, an institution, or a program of study.

5. The computing device of claim 1, wherein the first resource account and the one or more second resource accounts are managed by the same computing system.

6. The computing device of claim 1, wherein determining a resource allocation for the first resource account in connection with the first resource transfer operation comprises determining a second quantity of the resources of the first resource account that is designated for allocating to the first resource transfer operation.

7. The computing device of claim 1, wherein determining a resource allocation for the first resource account in connection with the first resource transfer operation comprises:
determining at least one contribution in connection with the first resource transfer operation based on the historical account operations data for the one or more second resource accounts; and
computing a difference between the first quantity of resources and the at least one contribution in connection with the first resource transfer operation.

8. The computing device of claim 7, wherein determining the at least one contribution in connection with the first resource transfer operation comprises obtaining scholarship amounts data based on the historical account operations data for the one or more second resource accounts.

9. The computing device of claim 7, wherein determining the at least one contribution in connection with the first resource transfer operation comprises obtaining income amounts data based on the historical account operations data for the one or more second resource accounts.

10. The computing device of claim 1, wherein detecting the second resource transfer operation associated with the first resource account comprises detecting at least one of: a cheque deposit transaction, a payment transaction, or a withdrawal transaction.

11. A processor-implemented method, comprising:
receiving, via a client device associated with a first resource account, a user input including selection of a first resource transfer operation and operation identifiers associated with the first resource transfer operation;
determining a first quantity of resources associated with the first resource transfer operation;
identifying one or more second resource accounts related to the first resource account based on matching account data of a plurality of resource accounts with the operation identifiers associated with the first resource transfer operation;
obtaining historical account operations data for the one or more second resource accounts;
determining a resource allocation for the first resource account in connection with the first resource transfer operation based on the first quantity of resources and the historical account operations data for the one or more second resource accounts;
detecting a second resource transfer operation associated with the first resource account; and
in response to detecting the second resource transfer operation associated with the first resource account:
determining that the second resource transfer operation results in a change to the resource allocation for the first resource account; and
transmitting, to the client device, a signal representing a notification indicating the change to the resource allocation.

12. The method of claim 11, wherein determining the first quantity of resources associated with the first resource transfer operation comprises:
determining second quantities of resources associated with the first resource transfer operation for the one or more second resource accounts; and
computing at least one average value based on the second quantities of resources.

13. The method of claim 12, further comprising transmitting, to the client device, a set of cost recommendations for display on the client device, the cost recommendations being based on the at least one average value.

14. The method of claim 11, wherein the operation identifiers associated with the first resource transfer operation indicate at least one of: a geographical region, an institution, or a program of study.

15. The method of claim 11, wherein the first resource account and the one or more second resource accounts are managed by the same computing system.

16. The method of claim 11, wherein determining a resource allocation for the first resource account in connection with the first resource transfer operation comprises determining a second quantity of the resources of the first resource account that is designated for allocating to the first resource transfer operation.

17. The method of claim 11, wherein determining a resource allocation for the first resource account in connection with the first resource transfer operation comprises:
determining at least one contribution in connection with the first resource transfer operation based on the historical account operations data for the one or more second resource accounts; and
computing a difference between the first quantity of resources and the at least one contribution in connection with the first resource transfer operation.

18. The method of claim 17, wherein determining the at least one contribution in connection with the first resource transfer operation comprises obtaining scholarship amounts data based on the historical account operations data for the one or more second resource accounts.

19. The method of claim 17, wherein determining the at least one contribution in connection with the first resource transfer operation comprises obtaining income amounts data based on the historical account operations data for the one or more second resource accounts.

20. The method of claim 11, wherein detecting the second resource transfer operation associated with the first resource account comprises detecting at least one of: a cheque deposit transaction, a payment transaction, or a withdrawal transaction.
